(19) United States
(12) Patent Application Publication
(10) Pub. No.: US 2008/0265463 A1
(43) Pub. Date: Oct. 30, 2008

(54) Split Mold Insert Positioning Device and a Method of Use

(75) Inventor: Jonah Irwin Finkelstein, Toronto (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, CA

(73) Assignee: Husky Injection Molding Systems Ltd., Bolton (CA)

(21) Appl. No.: 11/739,634

(22) Filed: Apr. 24, 2007

(51) Int. Cl. B29C 59/02

(52) U.S. Cl. 264/320; 425/525

(57) ABSTRACT

According to the embodiments of the present invention, there is provided a split mold insert positioning device and a method of use thereof. More specifically, a split mold insert positioning device is provided. The split mold insert positioning device comprises a split mold insert positioning interface dimensioned in a complementary arrangement to a reference dimension of a given split mold insert; and a tooling interface for providing access to the given split mold insert when the split mold insert positioning interface is positioned over the given split mold insert.

### FIELD OF THE INVENTION

The present invention generally relates to, but is not limited to, molding systems, and more specifically the present invention relates to, but is not limited to, a split mold insert positioning device and a method of use thereof.

### BACKGROUND OF THE INVENTION

Molding is a process by virtue of which a molded article can be formed from molding material by using a molding system. Various molded articles can be formed by using the molding process, such as an injection molding process. One example of a molded article that can be formed, for example, from polyethelene terephalate (PET) material is a preform that is capable of being subsequently blown into a beverage container, such as, a bottle and the like.

As an illustration, injection molding of PET material involves heating the PET material (ex. PET pellets, PEN powder, PLA, etc.) to a homogeneous molten state and injecting, under pressure, the so-melted PET material is injected into a molding cavity defined, at least in part, by a female cavity piece and a male core piece mounted respectively on a cavity plate and a core plate of the mold. The cavity plate and the core plate are urged together and are held together by clamp force, the clamp force being sufficient enough to keep the cavity and the core pieces together against the pressure of the injected PET material. The molding cavity has a shape that substantially corresponds to a final cold-state shape of the molded article to be molded. The so-injected PET material is then cooled to a temperature sufficient to enable ejection of the so-formed molded article from the mold. When cooled, the molded article shrinks inside of the molding cavity and, as such, when the cavity and core plates are urged apart, the molded article tends to remain associated with the core piece. Accordingly, by urging the core plate away from the cavity plate, the molded article can be demolded, i.e. ejected off of the core piece. Ejection structures are known to assist in removing the molded articles from the core halves. Examples of the ejection structures include stripper plates, ejector pins, etc.

When dealing with molding a preform that is capable of being blown into a beverage container, one consideration that needs to be addressed is forming a so-called “neck region”. Typically and as an example, the neck region includes (i) threads (or other suitable structure) for accepting and retaining a closure assembly (ex. a bottle cap), and (ii) an anti-pilferage assembly to cooperate, for example, with the closure assembly to indicate whether the end product (i.e. the beverage container that has been filled with a beverage and shipped to a store) has been tampered with in any way. The neck region may comprise other additional elements used for various purposes, for example, to cooperate with parts of the molding system (ex. a support ledge, etc.). As is appreciated in the art, the neck region can not be easily formed by using the cavity and core halves. Traditionally, split mold inserts (sometimes referred to by those skilled in the art as “neck rings”) have been used to form the neck region.

With reference to FIG. 1, a configuration of a typical neck ring and a neck ring slide will now be described in greater detail. More specifically, a first neck ring half 102a and a second neck ring half 102b jointly referred to herein below as a “neck ring pair 102”) cooperate to form the neck region of the preform. A plurality of first neck ring halves 102a is coupled to a first slide 104a. Similarly, a plurality of second neck ring halves 102b is also coupled to a second slide 104b. The first slide 104a and other first slides 104a potentially present in a mold are linked together for movement is substantial unison, for example, by means of a first set of connecting bars (not depicted). Similarly, the second slide 104b and other second slides 104b potentially present in the mold are linked together for movement is substantial unison, for example, by means of a second set of connecting bars (not depicted). A first cam system can be used to control the lateral movement of the plurality of first neck ring halves 102a along an axis “B” via the first set of connecting bars. A second cam system can be used to control the lateral movement of the plurality of second neck ring halves 102b into an opposite direction along the axis “B” relative to the first neck ring halves 102a via the second set of connecting bars. Alternatively, a single cam system can be used to control lateral movement of both the first and the second neck ring halves 102a, 102b relative to each other, for example, by means of a mechanical linkage between the first and second sets of connecting bars. Other types of actuators can also be used to effect the lateral movement of the first and the second neck ring halves 102a, 102b (for example, but not limited to, a servo motor and the like).

A typical first slide 104a (as well as the second slide 104b) comprises a positioning interface 106, a coupling interface 108 and a cooling interface 110. The positioning interface 106 comprises two spring pin receptacles that cooperate with two spring pins (not depicted) associated with the first neck ring half 102a. Even though not clearly visible in FIG. 1, the first neck ring half 102a comprises a corresponding positioning interface (not depicted), which can also comprise two spring pin receptacles, that cooperate with the two spring pins. As is known, the corresponding positioning interface (not depicted) provides a clearance that allows for a spring pin to shift within an associated spring pin receptacle. The coupling interface 108 typically comprises two bores, which cooperate with a complementary coupling interface 112 associated with the first neck ring half 102a and which comprises complementary two bores for accepting a fastener (such as a bolt, for example, or the like) therethrough to secure the first neck ring half 102a to the first slide 104a. The cooling interface 110 is used to supply coolant (such as water, etc.) from a source of coolant (not depicted) to the first neck ring half 102a.

The current procedure for mounting the first neck ring half 102a and the second neck ring half 102b will now be described in greater detail. A technician (or another representative of an entity managing a molding system that includes the neck rings and the slides or an entity of servicing the molding system), first positions the first neck ring half 102a to the first slide 104a and the second neck ring half 102b to the second slide 104b. This can be done, for example, by using the aforementioned spring pin and spring pin receptacle. It is important to recall that the corresponding positioning interface on the first neck ring half 102a is associated with some degree of clearance and, as such, allows certain degree of shift to the first neck ring half 102a relative to the first slide 104a and to the second neck ring half 102b relative to the second slide 104b. The first neck ring half 102a is then secured to the first slide 104a and the second neck ring half 102b is then secured to the second slide 104b using the aforementioned fasteners and the coupling interface 108 and the complementary coupling interface 112. Usually, there exists a pre-determined procedure associated with securing the first neck ring half 102a relative to the first slide 104a and the second neck ring half 102b relative to the second slide 104b. For example, a typical procedure may include finger-tightening of the fastener(s) until a respective O-ring (not depicted) placed between the first neck ring half 102a and the first slide 104a and the second neck ring half 102b and the second slide 104b is compressed and then torquing them to a pre-determined degree.

One of the main problems associated with the current procedure for mounting the neck ring pair 102 onto the first and second slides 104a, 104b is that it is susceptible to causing the first neck ring half 102a to be mis-aligned relative to the second neck ring half 102b. For example, the mis-alignment may occur along an axis “C” of FIG. 1. More specifically, due to the aforementioned fact that the positioning interface 106 is associated with certain degree of clearance, during torquing of the first neck ring half 102a and subsequent torquing of the second neck ring half 102b, they may become mis-aligned relative to each other. This mis-alignment is slightly exaggerated, but clearly visible in FIG. 2, which depicts a schematic top view of the first neck ring half 102a and the second neck ring half 102b in a mis-aligned arrangement, as depicted at “M”. The mis-alignment may also occur along an axis “B” of FIG. 1. Other types of mis-alignment may also happen within the prior art approaches. Irrespective of the type of mis-alignment, it can lead to premature surface wear of the first neck ring half 102a and/or the second neck ring half 102b (as well as the cavity and the cavity flange). As is very well known in the art, the first and second neck ring halves 102a, 102b are relatively expensive to manufacture and, as such, premature surface wear leads to increased costs.

### SUMMARY OF THE INVENTION

According to a first broad aspect of the present invention, there is provided a split mold insert positioning device. The split mold insert positioning device comprises a body defining a split mold insert positioning interface dimensioned in a complementary arrangement to a reference dimension of a given split mold insert; a tooling interface for providing access to the given split mold insert when the split mold insert positioning interface is positioned over the given split mold insert.

According to a second broad aspect of the present invention, there is provided a mold that includes a plurality of split mold inserts, the plurality of split mold inserts having been aligned by the split mold insert positioning device.

According to a third broad aspect of the present invention, there is provided a method of aligning a split mold insert using a positioning device, the positioning device comprising (i) a split mold insert positioning interface dimensioned in a complementary arrangement to a reference dimension of a given split mold insert, and (ii) a tooling interface for providing access to the given split mold insert when being aligned by the split mold insert positioning interface; the method comprising: positioning a first split mold insert and a second split mold insert onto a respective first and second split mold insert slides; positioning the positioning device over the first split mold insert and the second split mold insert so that the split mold insert positioning interface engages the reference dimension of the first split mold insert and the second split mold insert; securing the first split mold insert and the second split mold insert to a respective first and second split mold insert slides through the tooling interface.

According to another broad aspect of the present invention, there is provided a method of aligning a split mold insert using a positioning device, the positioning device comprising (a) a body defining (i) a split mold insert positioning interface dimensioned in a complementary arrangement to a reference dimension of a given split mold insert; and (ii) a tooling interface for providing access to the given split mold insert when being aligned by the split mold insert positioning interface and (b) a flexible positioning member separate from the body; the method comprising: placing the flexible positioning member over a core of a molding system; positioning a first split mold insert and a second split mold insert onto a respective first and second split mold insert slides; forcing the first split mold insert and the second split mold insert into a closed position, the flexible positioning member being retained between the first split mold half, the second split mold half and the core; positioning the positioning device over the first split mold insert and the second split mold insert so that the split mold insert positioning interface engages the reference dimension of the first split mold insert and the second split mold insert; securing the first split mold insert and the second split mold insert to a respective first and second split mold insert slides through the tooling interface.

According to yet another broad aspect of the present invention, there is provided a positioning device. The positioning device comprises a body defining a slide engagement member for cooperating, in use, with a split mold insert slide; a split mold insert positioning interface dimensioned in a complementary arrangement to a reference dimension of a given split mold insert; a tooling interface for providing access to the given split mold insert when being aligned by the split mold insert positioning interface.

According to yet another aspect of the present invention, there is provided an auxiliary positioning device for aligning split mold inserts.

A technical effect, amongst others, of the aspects of the present invention may include reduced neck ring wear, as well as the cavity and the cavity flange. Another technical effect of the aspects of the present invention may include decreased operating costs due to less frequent replacement of worn neck rings and/or cavity inserts. It should be expressly understood that not all of the technical effects, in their entirety, need be realized in each and every embodiments of the present invention.

### DESCRIPTION OF THE DRAWINGS

A better understanding of the embodiments of the present invention (including alternatives and/or variations thereof) may be obtained with reference to the detailed description of the exemplary embodiments along with the following drawings, in which:

FIG. 1 is a schematic representation of a neck ring pair and a neck ring slide, according to known prior art solutions.

FIG. 2 is a schematic top view representing a first neck ring half and a second neck ring half of FIG. 1, in a mis-aligned arrangement.

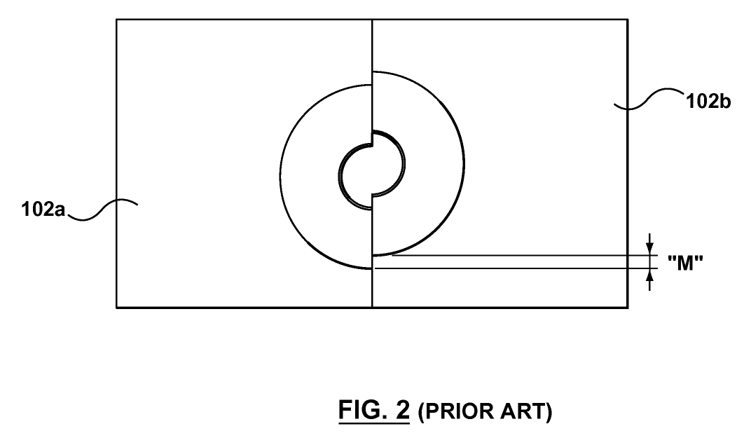

FIG. 3 is a perspective view of a positioning device according to a non-limiting embodiment of the present invention.

FIG. 4 is a perspective view of a bottom portion of a positioning device according to a non-limiting embodiment of the present invention.

FIG. 5 is a perspective view of a neck ring pair that can be aligned using the positioning device of FIG. 3, showing a tooling diameter thereof.

FIG. 6 is a perspective view of a positioning device according to another non-limiting embodiment of the present invention.

FIG. 7 is a perspective view of the neck ring pair and the neck ring slide of FIG. 1, as well as the alignment device of FIG. 6, partially in use.

The drawings are not necessarily to scale and are may be illustrated by phantom lines, diagrammatic representations and fragmentary views. In certain instances, details that are not necessary for an understanding of the exemplary embodiments or that render other details difficult to perceive may have been omitted.

### DETAILED DESCRIPTION OF EMBODIMENTS

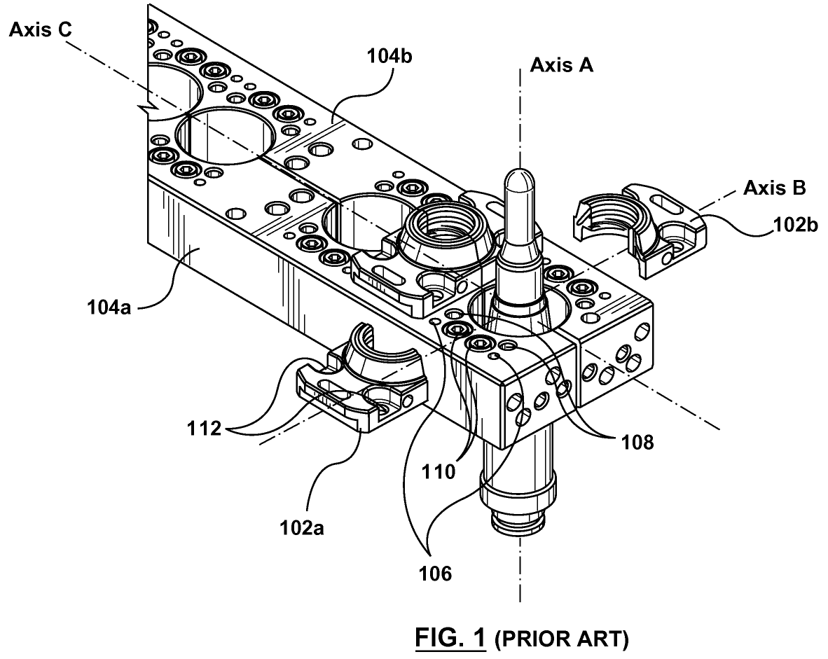

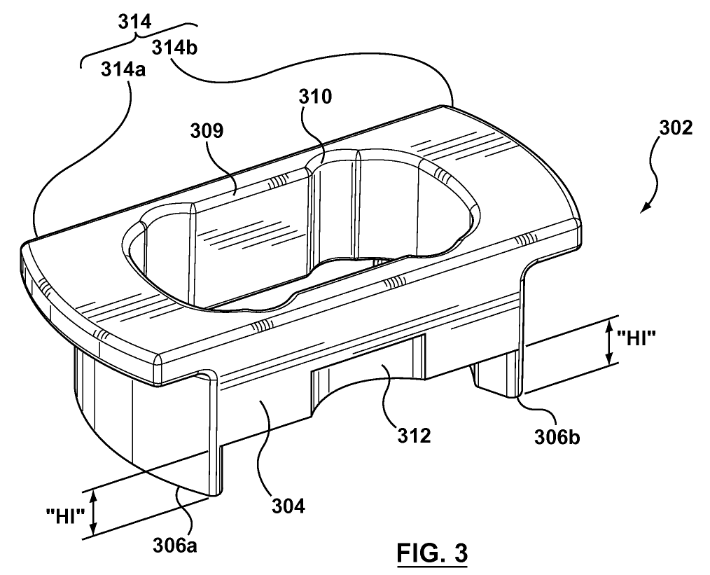

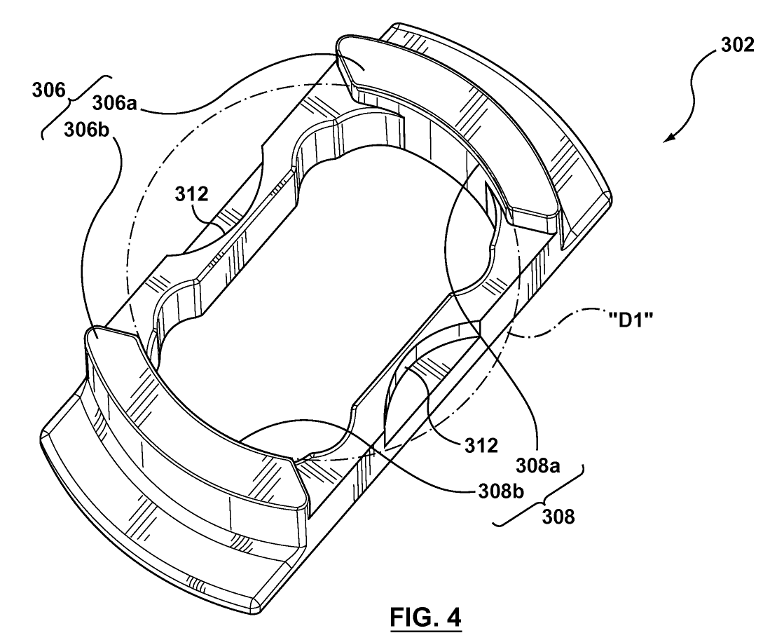

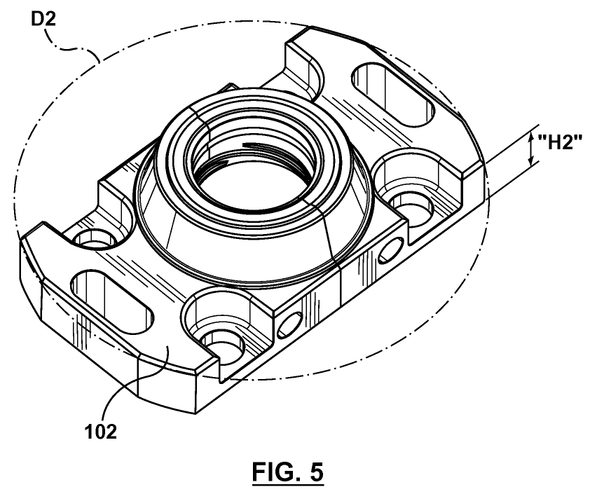

With reference to FIG. 3, FIG. 4 and FIG. 5, there is depicted a non-limiting embodiment of a positioning device 302 according to a non-limiting embodiment of the present invention. In some embodiments of the present invention, the positioning device 302 can be used to perform a method of aligning a split mold insert, such as for example, the first neck ring half 102a and the second neck ring half 102b of FIG. 1. The first neck ring half 102a and the second neck ring half 102b can be part of an injection molding system that is used for producing a preform capable of being blow-molded into a beverage container and the like. However, this need not be so in every embodiment of the present invention. It should be expressly understood that embodiments of the present invention can be used for aligning split mold inserts used in plastic molding systems, plastic compression systems, metal molding systems, glass molding systems, just to name a few examples. The positioning device 302 can be thought of as an “auxiliary positioning device” in the sense that it does not form part of the mold. However, this is not to say that the positioning device 302 can not be supplied together with a mold or a molding system.

For the purposes of the description to be presented herein below and as an illustration only, it shall be assumed that the positioning device 302 is used to align the first neck ring half 102a and the second neck ring half 102b of FIG. 1.

The positioning device 302 comprises a body 304. The body 304 defines a slide engagement member 306, which in the specific embodiment being described herein comprises a first slide engagement member 306a and a second slide engagement member 306b. In some embodiments of the present invention, the purpose of the first slide engagement member 306a and the second slide engagement member 306b is to position the body 304 onto a top surface of the first slide 104a and the second slide 104b, in an operating position. In some embodiments of the present invention, the first slide engagement member 306a and the second slide engagement member 306b can be precisely dimensioned to be substantially flat. In other words, each of the first slide engagement member 306a and the second slide engagement member 306b can be said to comprise a lowermost portion which can be substantially flat. However, it should be expressly understood that the first slide engagement member 306a and/or the second slide engagement member 306b may have certain deviations from this substantially flat configuration.

Each of the first slide engagement member 306a and the second slide engagement member 306b is associated with a height depicted in FIG. 3 at “H1”. In some embodiments of the present invention, the height “H1” generally corresponds to a height of the neck ring pair 102 to be aligned, as generally depicted at “H2” in FIG. 5. For example, the height H1 can be substantially equal to height H2. However, this need not be so in every embodiment of the present invention. For example, in alternative non-limiting embodiments of the present invention, the height H1 associated with the first slide engagement member 306a and the second slide engagement member 306b can be larger than the height H2 associated with the neck ring pair 102 to be aligned.

In alternative non-limiting embodiments of the present invention, the height H1 associated with the first slide engagement member 306a and the second slide engagement member 306b can be less than the height H2 associated with the neck ring pair 102 to be aligned. As will be appreciated, within these non-limiting embodiments of the present invention, the first slide engagement member 306a and the second slide engagement member 306b will not abut the top surface of the first slide 104a and the second slide 104b. Other configurations are, of course, possible.

The body 304 further comprises a positioning interface 308, which comprises a first positioning interface 308a associated with the first slide engagement member 306a and a second positioning interface 308b associated with the second slide engagement member 306b. Generally speaking, the positioning interface 308 is dimensioned in a complementary arrangement to correspond to a reference dimension of the neck ring pair 102 to be aligned.

In a first non-limiting example, the first positioning member 308a and the second positioning member 308b can define, in part, a first imaginary diameter D1. The first imaginary diameter D1 is complementary to a second imaginary diameter D2 associated with the neck ring pair 102 to be aligned (as is shown in FIG. 5). The second imaginary diameter D2 is referred to sometimes by those skilled in the art as a “tooling diameter” associated with the neck ring pair 102. As is known to those skilled in the art, the tooling diameter of the neck ring pair 102 is tightly controlled and is known a priori. For the avoidance of doubt, it should be clear that the first imaginary diameter D1 is complementary to the second imaginary diameter D2 in the sense that it is configured in a close fit tolerance arrangement. The purpose of the close fit tolerance arrangement is twofold: (a) to allow the positioning device 302 to be positioned over the neck ring pair 102 and (b) to provide close fit tolerance association between the positioning device 302 and the neck ring pair 102 to allow for using the tooling diameter as a reference dimension (or a reference axis) for aligning the neck ring pair 102. The exact dimension of the first imaginary diameter D1 will become apparent to those of skill in the art based on the tooling diameter of the neck ring pair 102 to be adjusted, as long as the above-recited functions are satisfied.

In a second non-limiting example, the reference dimension of the neck ring pair 102 can, for example, comprise a dimension of a top taper portion (not separately numbered) of the neck ring pair 102. Depending on implementation, other variants of the reference dimension associated with the neck ring pair 102 to be aligned can be used.

The body 304 further defines a tooling interface 309. The tooling interface 309 comprises a bore defined in an upper face of the body 304. The tooling interface 309 allows access to the neck ring pair 102, when the positioning device 302 is positioned over the neck ring pair 102. In the specific non-limiting embodiment depicted in FIG. 3, the tooling interface 309 defines four instances of a tool clearance member 310. Each instance of the tool clearance member 310 is positioned relative to location of each instance of the complementary coupling interface 112. The purpose of the tool clearance member 310 is to provide clearance for a ratchet (or another tool) used to torque the fasteners that are used to secure the neck ring pair 102 to the first slide 104a and the second slide 104b. It should be noted that in alternative non-limiting embodiments of the present invention, the tool clearance member 310 can be configured differently or omitted altogether, as will be described in greater detail herein below.

The body 304 further defines a neck ring clearance member 312. As is best seen in FIG. 4, the body 304 defines two instances of the neck ring clearance member 312, one on a front face of the body 304 and one on a back face of the body 304, opposite the front face. The purpose of the neck ring clearance member 312 is to provide clearance for a top taper portion of the neck ring pair 102 positioned next to the neck ring pair 102 being aligned using the positioning device 302 along an axis depicted in FIG. 1 at “C”.

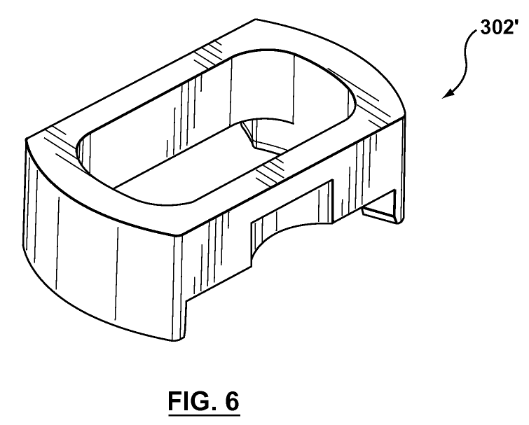

The body 304 further defines a handling member 314, which comprises a first handling member portion 314a and a second handling member portion 314b defined at opposite extremes of the body 304. The purpose of the first handling member portion 314a and the second handling member portion 314b is to allow easy handling of the positioning device 302 by a technician. It should be understood, that the shape of the first handling member portion 314a and the second handling member portion 314b can be varied. It should be further noted that in alternative non-limiting embodiments of the present invention, the first handling member portion 314a and/or the second handling member portion 314b can be omitted altogether. An example of an alternative implementation of a positioning device 302′ is depicted in FIG. 6. The positioning device 302′ is substantially similar to the positioning device 302, but does not include the handling member 314. The positioning device 302′ further does not include the tool clearance member 310. Other alternatives and variations will become apparent to those skilled in the art, having benefit of the teachings of the present invention.

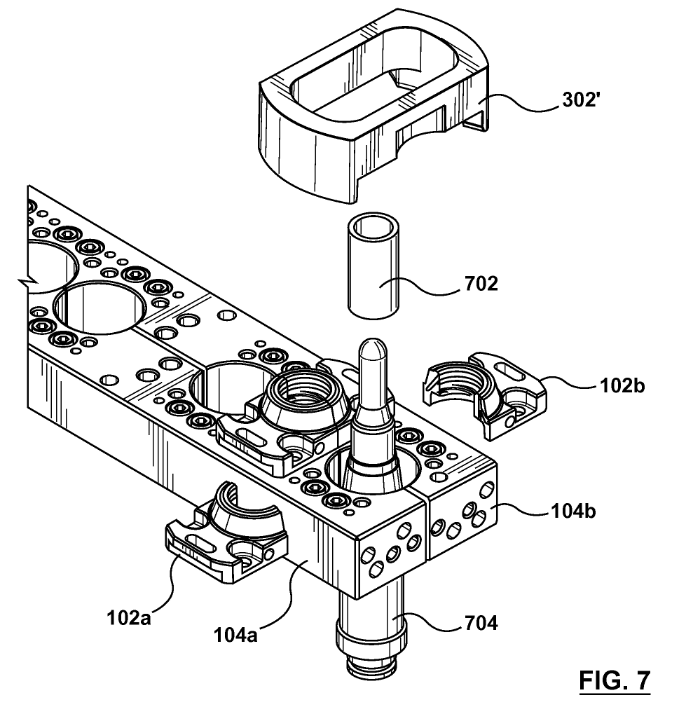

With reference to FIG. 7, there is shown a flexible positioning member 702. The flexible positioning member 702 can comprise a sleeve that can be placed over at least a portion of a core 704. Alternatively, the flexible positioning member 702 can comprise any other suitable shape that can be wrapped around at least a portion of the core 704. The flexible positioning member 702 can be made of any suitable flexible material, such as, for example silicon foam, rubber, etc. As will be described momentarily, the purpose of the flexible positioning member 702 is to position, in cooperation with the positioning device 302, 302′, the neck ring pair 102 relative to the core 704. It should be noted, however, that the flexible positioning member 702 is an optional feature and, as such, may be omitted in certain alternative non-limiting embodiments of the present invention.

With continued reference to FIG. 7, operation of the positioning device 302′ will be described in greater detail. It is expected that those skilled in the art will easily adapt the sequence of steps to be described above to operation of the positioning device 302.
Step A. The flexible positioning member 702 is placed over a portion of the core 704. For example, the flexible positioning member 702 can be slid over the core 704 along an axis depicted in FIG. 1 at “A”. Alternatively, the flexible positioning member 702 can be wrapped around the portion of the core 704 and secured by suitable means, as will be appreciated by those of skill in the art.
Step B. The neck ring pair 102 to be aligned is then positioned on the respective first slide 104a and the second slide 104. The aforementioned positioning interface 106 (i.e. the spring pins and the spring pin receptacles) can be used for carrying out this step. In some embodiments of the present invention, prior to positioning of a first instance of the neck ring pair 102, the first slide 104a and the second slide 104b are first positioned. This positioning can be carried out, for example, relative to and using a cam system (not depicted) used to drive the first slide 104a and the second slide 104b. Other alternative method for positioning of the first slide 104a and the second slide 104b can also be used.
Step C. The neck ring pair 102 is brought into a closed position and the positioning device 302′ is placed over the neck ring pair 102. At this point two things will occur: (a) the flexible positioning member 702 will fill any gaps between an inside face of the neck ring pair 102 and an outer surface of the core 704 and, as such, align the neck ring pair 102 relative to the core 704; and (b) the positioning interface 306 will engage the tooling diameter of the neck ring pair 102 and, as such, align the first neck ring half 102a relative to the second neck ring half 102b using the tooling diameter of the neck ring pair 102 as a reference dimension.
Step D. Using a ratchet (or another suitable tool), a technician secures the first neck ring half 102a to the first slide 104a and the second neck ring half 102b to the second slide 104b through the tooling interface 309. It will be understood that, for the purposes of simplifying this description, the description of step D is greatly simplified. As such, step D may include a number of additional sub-steps, such as finger-tightening, torquing, greasing and other steps, as per known procedures.

Steps A-D are then repeated for the next instance of the neck ring pair 102 to be aligned in substantially the same fashion. However, other alternative are possible. For example, it is contemplated that a technician can first place the flexible positioning member 702 onto every instance of the core 704 associated with every instance of neck ring pair 102 to be aligned. Similarly, it is contemplated that step B can be executed for every instance of the neck ring pair 102 to be aligned, before moving to the remainder of the steps. Other variations are, of course, possible.

In these embodiments of the present invention, a technical effect includes alignment of the neck ting pair 102 relative to the core 704 (due to the use of the flexible positioning member 702) and alignment of the first neck ring half 102a relative to the second neck ring half 102b (due to the complementary arrangement of the positioning member 108 and the tooling diameter of the neck ring pair 102).

However, in alternative embodiments of the present invention, the positioning device 302, 302′ can be used without the flexible positioning member 702 and, as such, the above-described step A can be omitted. Within these embodiments of the present invention, a technical effect includes alignment of the first neck ring half 102a relative to the second neck ring half 102b.

It should be noted that even though the positioning device 302, 302′ has been described as a unitary structure, this needs not be so in every embodiment of the present invention. In alternative embodiments of the present invention, the positioning device 302, 302′ can be formed of two (or more) substructures. For example, the positioning device 302, 302′ may be configured of two halves that are secured together by a fastener (such as a bolt and the like). Other alternatives are also possible.

The description of the embodiments of the present inventions provides examples of the present invention, and these examples do not limit the scope of the present invention. It is to be expressly understood that the scope of the present invention is limited by the claims only. The concepts described above may be adapted for specific conditions and/or functions, and may be further extended to a variety of other applications that are within the scope of the present invention. Having thus described the embodiments of the present invention, it will be apparent that modifications and enhancements are possible without departing from the concepts as described. Therefore, what is to be protected by way of letters patent are limited only by the scope of the following claims:

1. A split mold insert positioning device comprising:
a body defining:
a split mold insert positioning interface dimensioned in a complementary arrangement to a reference dimension of a given split mold insert;
a tooling interface for providing access to the given split mold insert when said split mold insert positioning interface is positioned over the given split mold insert.

2. The split mold insert positioning device of claim 1, wherein said reference dimension comprises a tooling diameter of the given split mold insert.

3. The split mold insert positioning device of claim 2, wherein said split mold insert positioning interface defines an imaginary diameter and wherein said imaginary diameter is configured in a close fit tolerance arrangement with the tooling diameter of the given split mold insert.

4. The split mold insert positioning device of claim 1, wherein said reference dimension comprises a diameter of a top taper portion of the given split mold insert.

5. The split mold insert positioning device of claim 1, wherein said slide engagement member is associated with a first height.

6. The split mold insert positioning device of claim 5, wherein said first height is complementary to a second height associated with the given split mold insert.

7. The split mold insert positioning device of claim 5, wherein said first height is substantially the same as a second height associated with the given split mold insert.

8. The split mold insert positioning device of claim 5, wherein said first height is greater than a second height associated with the given split mold insert.

9. The split mold insert positioning device of claim 5, wherein said first height is smaller than a second height associated with the given split mold insert.

10. The split mold insert positioning device of claim 1, further comprising a slide engagement member for cooperating, in use, with a split mold insert slide.

11. The split mold insert positioning device of claim 10, wherein said slide engagement member comprises a first slide engagement member and a second slide engagement member disposed on opposing sides of said body.

12. The split mold insert positioning device of claim 11, wherein said split mold insert positioning interface comprises a first split mold insert positioning interface associated with said first slide engagement member and a second split mold insert positioning interface associated with said second slide engagement member.

13. The split mold insert positioning device of claim 11, wherein each of said first slide engagement member and said second slide engagement member comprises a substantially flat lowermost surface.

14. The split mold insert positioning device of claim 1, wherein said tooling interface defines at least one tool clearance member positioned to correspond to a position of at least one coupling interface of the given split mold insert.

15. The split mold insert positioning device of claim 1, further comprising a flexible positioning member separate from said body, said flexible positioning member configured to cooperate with a core of a molding system.

16. The split mold insert positioning device of claim 15, wherein said flexible positioning member comprises a sleeve.

17. The split mold insert positioning device of claim 15, wherein said flexible positioning member comprises a member wrapable around the core of a molding system.

18. A mold having a plurality of split mold inserts, the plurality of split mold inserts having been aligned by the split mold insert positioning device of claim 1.

19. A method of aligning a split mold insert using a positioning device, the positioning device comprising (i) a split mold insert positioning interface dimensioned in a complementary arrangement to a reference dimension of a given split mold insert, and (ii) a tooling interface for providing access to the given split mold insert when being aligned by said split mold insert positioning interface; the method comprising:.
positioning a first split mold insert and a second split mold insert onto a respective first and second split mold insert slides;
positioning the positioning device over said first split mold insert and said second split mold insert so that the split mold insert positioning interface engages the reference dimension of said first split mold insert and said second split mold insert;
securing said first split mold insert and said second split mold insert to a respective first and second split mold insert slides through the tooling interface.

20. The method of claim 19, further comprising removing the positioning device from said first split mold insert and said second split mold insert.

21. The method of claim 20, further repeating the method for a second set of the first split mold insert and the second split mold insert.

22. The method of claim 19, wherein said reference dimension comprises a tooling diameter of the split mold insert.

23. The method of claim 19, wherein said reference dimension comprises a diameter of a top taper portion of the given split mold insert.

24. A method of aligning a split mold insert using a positioning device, the positioning device comprising (a) a body defining (i) a split mold insert positioning interface dimensioned in a complementary arrangement to a reference dimension of a given split mold insert; and (ii) a tooling interface for providing access to the given split mold insert when being aligned by the split mold insert positioning interface and (b) a flexible positioning member separate from the body; the method comprising:
placing the flexible positioning member over a core of a molding system;
positioning a first split mold insert and a second split mold insert onto a respective first and second split mold insert slides;
forcing the first split mold insert and the second split mold insert into a closed position, the flexible positioning member being retained between the first split mold half, the second split mold half and the core;
positioning the positioning device over said first split mold insert and said second split mold insert so that the split mold insert positioning interface engages the reference dimension of said first split mold insert and said second split mold insert;
securing said first split mold insert and said second split mold insert to a respective first and second split mold insert slides through the tooling interface.

25. The method of claim 24, further comprising removing the positioning device from said first split mold insert and said second split mold insert.

26. The method of claim 24, further comprising removing said flexible positioning member.

27. The method of claim 24, wherein said placing of the flexible positioning member over a core of a molding system comprises placing a respective flexible positioning member over each of a plurality of cores of the molding system.

28. The method of claim 24, wherein said positioning a first split mold insert and a second split mold insert onto a respective first and second split mold insert slides comprises positioning a plurality of first split mold insert and a plurality of second split mold insert onto a respective plurality of first and second split mold insert slides.

29. A positioning device comprising:
a body defining:
a slide engagement member for cooperating, in use, with a split mold insert slide;
a split mold insert positioning interface dimensioned in a complementary arrangement to a reference dimension of a given split mold insert;
a tooling interface for providing access to the given split mold insert when being aligned by the split mold insert positioning interface.

30. The positioning device of claim 29, wherein said reference dimension comprises a tooling diameter of the given split mold insert.

31. The positioning device of claim 29, wherein said reference dimension comprises a diameter of a top taper portion of the given split mold insert.

32. The positioning device of claim 29 implemented in a unitary structure.

33. The positioning device of claim 29, implemented in an assembled structure having two or more sub-components.

34. An auxiliary positioning device for aligning split mold inserts.
